(19) United States
(12) Patent Application Publication
(10) Pub. No.: US 2010/0100589 A1
(43) Pub. Date: Apr. 22, 2010

(54) APPARATUS AND METHOD FOR MEASURING ADVERTISING METRICS

(75) Inventors: Hae-Young JUN, Anyang-si (KR); Seok-Hoon Choi, Seongnam-si (KR); Ji-Hye Lee, Suwon-si (KR)

Correspondence Address: THE FARRELL LAW FIRM, LLP, 290 Broadhollow Road, Suite 210E, Melville, NY, 11747, US

(73) Assignee: Samsung Electronics Co., Ltd., Suwon-si (KR)

(21) Appl. No.: 12/581,642

(22) Filed: Oct. 19, 2009

(30) Foreign Application Priority Data
Oct. 17, 2008 (KR) 10-2008-0102226

(51) Int. Cl. G06F 15/16

(52) U.S. Cl. 709/203

(57) ABSTRACT

Disclosed is a method of measuring advertisement use details suitable for an advertisement content type and advertisement purposes, by setting metrics measurement criteria to be measured for each advertisement at an advertisement server that provides an advertisement, and transmitting the set criteria and advertisement contents to an advertisement client. Thus, the advertisement client can measure advertisement use details for each advertisement based on that criteria and report metrics information, that is the measurement result, to the advertisement server. By this, the advertisement server may grasp in real time each user's response to advertisements having different formats so that the measurement of advertising effects is possible, and according to this, a more differentiated, customized advertisement service can be provided in the future or it can be used as a basis for charging an advertiser.

### PRIORITY

This application claims priority under 35 U.S.C. §119(a) to an application entitled “Apparatus and Method For Measuring Advertising Metrics” filed in the Korean Industrial Property Office on Oct. 17, 2008 and assigned Serial No. 10-2008-0102226, the contents of which are incorporated herein by reference.

### BACKGROUND OF THE INVENTION

1. Field of the Invention

The present invention relates to a mobile advertising system for providing a differentiated, customized Mobile Advertising (MobAd) service to a user, and more particularly to an apparatus and a method for measuring metrics indicative of the advertisement exposure and a user response record in a mobile advertising system.

2. Description of the Related Art

The Open Mobile Alliance (OMA) is a standards body that develops standards for the interaction of separate mobile solutions. The OMA mainly serves to prescribe various application standards for mobile games, internet services, etc. In particular, the Open Mobile Alliance Requirement Working Group (OMA REQ) and the Open Mobile Alliance Content Delivery Working Group (OMA CD) among OMA working groups are developing a technology standard of a Mobile Advertising (MobAd) service.

The components and the operation of a MobAd system that realizes the mobile advertising service technology will be described with reference to FIG. 1. FIG. 1 illustrates the construction diagram of the components and the interfaces between the components of a general mobile advertising system. Referring to FIG. 1, a mobile advertising system mainly includes an Ad engine and an Advertising (Ad) server, the Ad engine corresponding to an advertisement client 100 and the Ad server corresponding to an advertisement server 110.

The advertisement client 100 is located in a terminal, and is used to access the Ad server. The advertisement client 100 refers to a function group comprised of logical modules, and accesses the advertisement server 110 using a TBD(To Be Determined)-2 interface. In addition, the advertisement client 100 exchanges service management information with the advertisement server 110, and performs such functions as receiving a proper advertisement from the advertisement server 110, managing the received advertisement, selecting an advertisement store from a terminal store, providing advertisement related feedback to the advertisement server 110, filtering, and the like.

The advertisement server 110 provides an application-based network function for the benefit of a mobile advertisement service. The advertisement server 110 exchanges service managing information with the advertisement client 100, and presents an advertisement and an advertisement notification for the advertisement server 110. Between the advertisement server 110 and the service provider application 120 providing a mobile advertisement, the TBD-1 interface is used. A contextualization and personalization module 140 communicates with the advertisement server 110 via a TBD-4 interface and also communicates with the advertisement client via a TBD-5 interface.

The above-mentioned mobile advertisement system measured metrics between an advertisement provider and an advertisement user according to a previously appointed rule. For instance, the advertisement exposure frequency and the exposure time to a user or the number of times an advertisement has been clicked and the like were measured by a predefined rule, and all advertisement clients recorded the corresponding advertisement use with a same index, and then such use records were transferred to the advertisement provider or the advertisement server.

Also, in the case of a wired network having relatively unlimited resources for data transfer, click information may be transmitted to the advertisement server as soon as a user clicks on an advertisement. At this time, the advertisement server must receive the advertisement consumption status continuously and thus directly make an accumulation/statistics thereof.

As described above, the prior art advertisement server and advertisement client/application examined advertisement use details only by monolithic criteria independent of the overall advertisement content. That is, measurements over and above criteria that is prearranged or unilaterally set by an advertisement application or an advertisement client, such as exposure time or clicking time, independent of an advertisement contents type, were performed. As such, a measurement function for an advertisement type and advertisements purpose was not implemented in the conventional mobile advertisement service technology, and thus methods of solving this problem are needed.

### SUMMARY OF THE INVENTION

Accordingly, the present invention has been made to solve at least the above-mentioned problems occurring in the prior art, and the present invention provides an apparatus and a method of measuring advertisement metrics to monitor and report advertisement use details in conformity with an advertisement content type and advertisements purpose.

In accordance with an aspect of the present invention, there is provided a method of measuring advertisement metrics in a mobile advertisement system including an advertisement server, an advertisement client and an advertisement application, including receiving an advertisement package containing metrics measurement criteria to be measured for each advertisement by the advertisement client, transmitting advertisement content and the metrics measurement criteria within the advertisement package to the advertisement application, receiving metrics information that is an advertisement measurement result based on the metrics measurement criteria from the advertisement application, storing the metrics information each time the metrics information is transmitted, and delivering the corresponding metrics information to the advertisement server.

In accordance with another aspect of the present invention, there is provided an apparatus for measuring advertisement metrics including an advertisement transmitting/receiving unit for receiving and storing an advertisement package containing metrics measurement criteria to be measured for each advertisement and transmitting advertisement content and the metrics measurement criteria within the advertisement package to an advertisement application, and a reporting unit for storing metrics information that is an advertisement measurement result based on the metrics measurement criteria from the advertisement application and delivering the corresponding metrics information to the advertisement server.

### BRIEF DESCRIPTION OF THE DRAWINGS

The above and other aspects, features and advantages of the present invention will be more apparent from the following detailed description taken in conjunction with the accompanying drawings, in which:

FIG. 1 is a block diagram of components and interfaces of a general mobile advertisement system;

FIG. 2 is a block diagram of a system for advertisement metrics according to an embodiment of the present invention;

FIG. 3 is a block diagram of an advertisement server according to an embodiment of the present invention;

FIG. 4 is a block diagram of an advertisement client according to an embodiment of the present invention; and

FIG. 5 is a flow chart of an operation among the components of a system for measuring advertisement metrics according to an embodiment of the present invention.

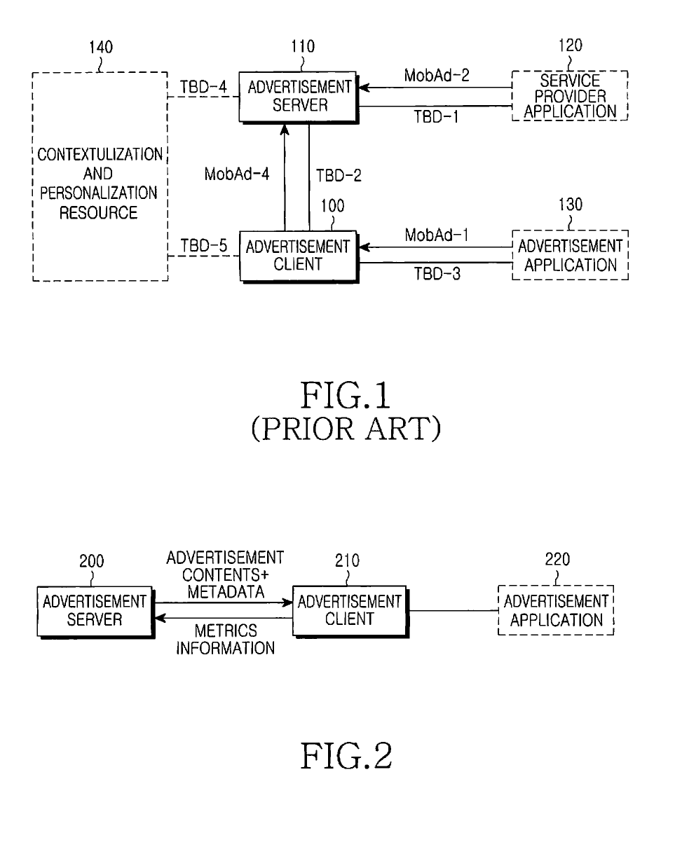

### DETAILED DESCRIPTION OF THE EXEMPLARY EMBODIMENT

Hereinafter, embodiments of the present invention will be described with reference to the accompanying drawings. In the drawings, the same elements will be designated by the same reference numerals possibly throughout the entire drawings. Further, a detailed description of known functions and configurations incorporated herein will be omitted when it may make the subject matter of the present invention rather unclear.

In the following description, a representative embodiment of the present invention for solving the above mentioned technical problems is presented. Also, for the convenience of describing the present invention, the descriptions of objects defined in the 3^{rd} Generation Partnership Project (3GPP), that is the 3^{rd} mobile communication standard, or in the Mobile Advertising (MobAd) of the Open Mobile Alliance (OMA), that is a mobile terminal application, will be used. However, the present invention is not limited to these standards and descriptions and it also can be applied to a system having a similar technical background.

The present invention provides a method of measuring advertisement use details in conformity with an advertisement contents type and advertisements purpose. To do this, the present invention sets metrics measurement criteria to be measured for each advertisement at an advertisement server that provides an advertisement, and transmits the set criteria and advertisement content to an advertisement client. Thus, the advertisement client can measure advertisement use details for each advertisement based on that criteria, and report metrics information, that is the measurement result, to the advertisement server. By this, the advertisement server can analize in real time each user's response to advertisements having different forms by using differential criteria, and thus not only can measure the advertisement effects, but also, based on this, can provide a more differentiated, customized advertisement service in the future.

FIG. 2 illustrates the construction of a system according to an embodiment of the present invention, wherein the system realizes a method of measuring a smart metrics in conformity with an advertisement contents type and/or advertisement purposes.

Referring to FIG. 2, an advertisement server 200 is an advertisement providing master, and also has a function of generating an advertisement. Herein, there exist an advertisement generating server and an advertisement managing server, but in an embodiment of the present invention, both of them are referred to as an advertisement server collectively.

The advertisement server 200 sets metrics criteria for measuring advertisement use details for each advertisement, and provides this criteria and advertisement content to an advertisement client 210. Specifically, the advertisement server 200 can set metrics criteria having a different measuring method and measurement data based on whether the advertisement content is a text or a flash/moving images, that is based on the kind of an individual advertisement content, or set metrics criteria having a different measuring method and measurement data for each advertisement based on variables set by an advertiser, even if content have the same format. Also, the advertisement server 200 can set metrics criteria for obtaining information needed to measure to what extent the advertisement effects can fulfill the advertisement goal set by an advertiser. For example, the present invention can set metrics criteria for reporting advertisement use details including the exposed number or the number of times an advertisement is clicked on indicating the advertisement use number of a user, a user's access time to an advertisement, and context information of a terminal, for example, neighbor context information of a terminal such as its location, etc.

Such metrics criteria can be transmitted to an advertisement client 200 in an advertisement package format including advertisement content. Particularly, in the following description, a method of transmitting metrics criteria using metadata of content according to an embodiment of the present invention will be described by way of an example, but the metadata can also be included and transferred in an advertisement package in a separate, additional information. In this case, the advertisement package can be formed as additional data containing advertisement content, metadata of the content and metrics measurement criteria. Normally, the metadata part of the advertisement content includes only additional information regarding the content. That is, information regarding who made the content and when the content was made as well as the kind of advertisement content, for example, whether the advertisement content is a text or flash/moving images and the size of the content, is included. The present invention can be characterized by requesting the advertisement client 200 of measuring a metadata part of the advertisement content or using the metadata part of the advertisement content to set the metrics measurement criteria.

An advertisement package created in the advertisement server 200 can be divided into an advertising content part and a metadata part. In the advertising contents part, an actual advertising content is inserted including a text/flash/moving images/sound or the like. Also, in the metadata part, metrics measurement criteria set for advertisement measurement along with additional information regarding advertising contents are inserted.

In the following Table 1, one example of setting the metrics measurement criteria is presented.

TABLE 1

```
<MetricsCriteria>
    <Time> StartTime </Time>
    <Time> EndTime </Time>
    <Time> Duration </Time>
    <Number> NumberOfClick </Number>
    <Location> LocationOfClick </Location>
    <Location> LocationOfDisplay </Location>
    <Number> NumberOfForwarding </Number>
    ...
</MetricsCriteria>
```

The above Table 1 shows Start Time, End Time, Duration, Number of Click, Location of Click, Location of Display, Number of Forwarding, etc., as a metrics measurement criterion, representing what advertisement use details must be reported from an advertisement client to an advertisement server.

Table 1 illustrates one example of setting metrics measurement criteria, and this is one method of XML-based metadata representation. According to the present invention, any other metadata representation methods for adding metrics measurement criteria to a metadata previously used to only transmit additional information of advertisement content can be employed, and thus the present invention is not limited to the above indicated method. As described above, the present invention can provide the advertisement client 210 and/or the advertisement application 220 with an advertising measurement method by adding an item regarding what element should be considered to perform the advertising measurement to the metadata when the advertisement content is executed through an advertisement application.

When the advertisement client 210 receives an advertisement package, the advertisement client 210 first obtains basic additional information regarding advertisement content from the metadata. Also, the advertisement client 210 can grasp which values should be measured and reported for each advertisement by analyzing the metadata. At this time, the execution of an actual advertisement content and advertisement exposure may be performed by the advertisement application 220. Thus, the advertisement client 210 can transmit the advertisement package as a state that it is received from the advertisement server 200 to the advertisement application 220, or transmit an advertisement package where only the metrics measurement criteria needed for advertisement measurement is excluded from the metadata. That is, the metrics measurement criteria can be transmitted only up to the advertisement client 210. In this case, the advertisement client 210 can gather and store metrics information solely suitable for its own metrics criteria from the pieces of metrics information that are measured arbitrarily and sent by the advertisement application 220.

As described above, either the advertisement client 210 or the advertisement application 220 can analyze the metadata for advertisement measurement, and in another way, both of the components can analyze the metadata.

When the advertisement application 220 performs advertising measurement according to metrics criteria, a piece of metrics information, that is the measurement result based on the metrics measurement criteria inserted by the advertisement server 200 into the metadata, may be transmitted to the advertisement client 210. That is, each time an advertisement measurement according to the metrics criteria is performed, the corresponding metrics information can be transmitted to the advertisement client 210. For example, when the advertisement content is executed in the advertisement application 220, and the advertisement is exposed to a user or a user clicks on it, an advertisement use occurs. Then, the measurement result is transmitted to the advertisement client 210 if the advertisement use is suitable for the metrics measurement criteria set by the advertisement server 200. When the measurement result, that is metrics information, is transmitted, the advertisement client 210 analyzes or stores the measurement result. In another way, the advertisement client 210 can forward the transmitted metrics information to the advertisement server 200. At this time, the forwarding to the advertisement server 200 may be performed immediately or it may be performed when there is a request from the advertisement server 200, or it may be gathered for a certain time for transmission.

In another example, if the advertisement client 210 gathers metrics information for an advertisement use using the metrics measurement criteria, then the advertisement application 220 transmits the overall information related to the advertisement use irrespective of the metrics measurement criteria to the advertisement client 210. The advertisement client 210 selects and stores information needed with respect to the metrics measurement criteria values included in the metadata among the transmitted advertisement use information. For example, if the advertisement client 210 grasps through metadata analysis that it is set to measure the overall time when an advertisement is exposed among metrics measurement criteria, the advertisement client 210 can measure the overall exposure time and send it to the advertisement server 200 using information such as an advertisement running time and an advertisement ending time among metrics information transmitted from the advertisement application 220.

As described above, the advertisement client 210 and/or the advertisement application 220 performs a smart metrics measurement of monitoring advertisement use details suitable for an advertisement content type and/or advertisement purposes according to a different metrics criterion for each advertisement and reporting it to the advertisement server 200. By measuring advertisement use details according to metrics criteria and reporting the metrics information, that is the measurement result, to the advertisement server 200, the advertisement server 200 can measure the advertisement effects such as how successful the advertisement performance result is and how effective in terms of cost for each advertisement.

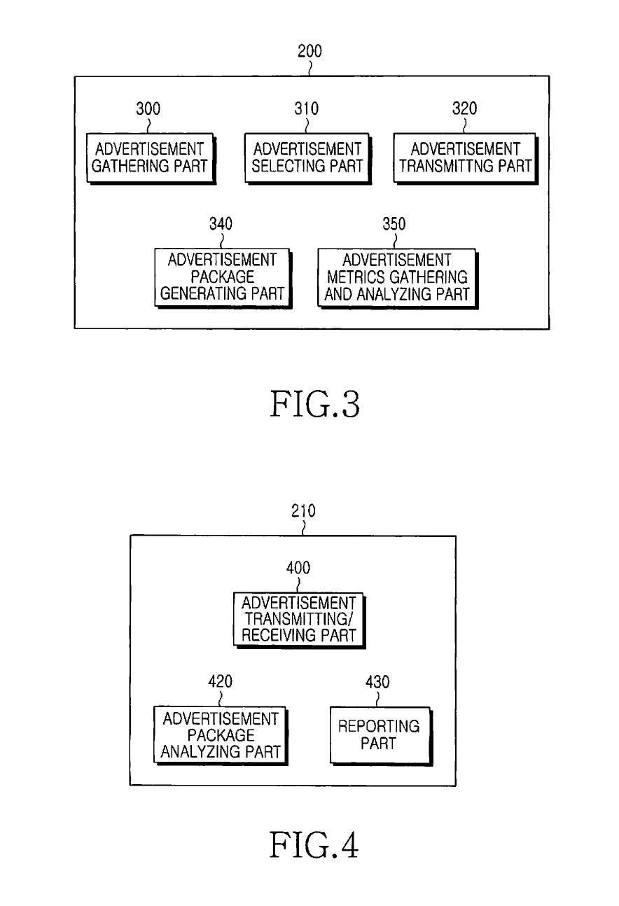

Hereinafter, the detailed construction of the advertisement server 200 and the advertisement client 210 as described above will be described. FIG. 3 is a block diagram of the advertisement server according to an embodiment of the present invention.

Referring to FIG. 3, an advertisement server 200 includes an advertisement gathering part 300, an advertising selection part 310, an advertising transmission part 320, an advertisement characteristic analyzing part 330, an advertisement package generating part 340 and an advertisement metrics gathering and analyzing part 350.

The advertisement gathering part 300 serves to receive advertisement content from an advertiser or an advertisement provider or store advertisement content beforehand.

The advertising selection part 310 serves to select an optimal advertisement by utilizing a user, a profile of an advertisement application, terminal information, etc. available in the advertisement server 200.

The advertisement transmitting part 320 serves to transmit the selected advertisement to the advertisement client 210 with or without a request of the advertisement client 210.

The advertisement package generating part 340 serves to create an advertisement package by setting metrics measurement criteria to be measured for each advertisement and inserting the set metrics measurement criteria into a metadata in a predefined format. The advertisement package refers to one package that is configured as advertisement+metadata or advertisement+metadata+additional information, and transmitted to the advertisement client 210.

The advertisement metrics gathering and analyzing part 350 serves to receive metrics information that is a measurement result according to the received advertisement use from the advertisement client 210 and analyze the results when necessary.

FIG. 4 is a block diagram of the advertisement client according to an embodiment of the present invention. The advertisement client 210 includes an advertisement transmitting/receiving part 400, an advertisement characteristic transmitting/receiving part 410, an advertisement package analyzing part 420 and a reporting part 430.

The advertisement transmitting/receiving part 400 serves to receive and store an advertisement from the advertisement server 200 and also to transmit the advertisement to the advertisement application 220.

The advertisement package analyzing part 420 analyzes a metadata within the advertisement package received from the advertisement server 200, and grasps the metrics measurement criteria representing what advertisement use details should be measured and reported, through the analysis result. If metrics information includes terminal context information as a result of the metadata analysis, the advertisement package analyzing serves to collect the corresponding terminal context information.

Also, the reporting part 430 can selectively gather and store metrics information only, part 420 suitable for the metrics measurement criteria extracted by the advertisement client 200 from the advertisement package among the metrics information transmitted from the advertisement application 220, and transmit it to the advertisement server 220.

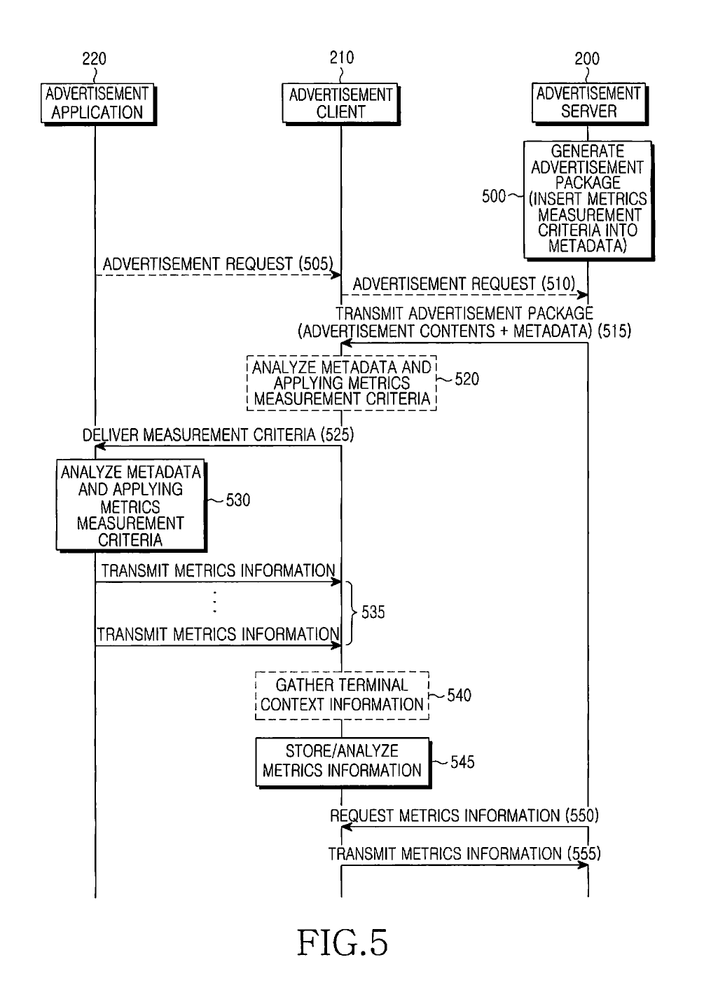

Hereinafter, the operation procedure among the components of a system for measuring advertisement metrics according to an embodiment of the present invention will be described with reference to FIG. 5.

Referring to FIG. 5, an advertisement server 200 generates an advertisement package at step 500. Specifically, when generating an advertisement package comprised of advertisement content and metadata, the advertisement server 200 inserts metrics measurement criteria representing which value should be measured in measuring/reporting advertisement use details to the metadata of the advertisement content. Such an advertisement package is held in the advertisement server 200, and if an advertisement request from the advertisement application 220 at step 505 is delivered through the advertisement client 210 at step 510, the advertisement server 200 sends the advertisement package created by the aforementioned procedure to the advertisement client 210 at step 515. That is, the advertisement package includes the very advertisement content and a metadata of the advertisement content, and also the metrics measurement criteria for the advertisement measurement are inserted in the metadata.

When receiving the advertisement package, the advertisement client 210 analyzes the metadata in the advertisement package and applies the metrics measurement criteria to set values to be measured and stored for the corresponding advertisement contents at step 520. Here, if the advertisement criteria only apply to the advertisement application 220, such metrics measurement criteria application can be omitted in the advertisement client 210. Next, the advertisement client 210 forwards the received advertisement package to the advertisement application 220 at step 525. In another way, the advertisement client 210 can extract the advertisement content and the metrics measurement criteria from the advertisement package, and forward only metadata excluding the advertisement and the metrics measurement criteria.

When receiving the advertisement package, the advertisement application 220 analyzes the metadata and determines what sort of measurement results need to be transmitted to the advertisement client 210. To do this, the advertisement application 220 analyzes the metadata and applies the metrics measurement criteria at step 530. Next, the advertisement application 220 starts to measure advertisement use details of a user according to the metrics criteria. For instance, whether to measure the advertisement is determined according to the metrics measurement criteria considering some measuring elements, for example, if the advertisement is exposed to the user, or the user clicked on it, etc. Accordingly, considering the corresponding measuring elements, the advertisement application 220 transmits metrics information, that is the measurement result, to the advertisement client 210 at step 535. Then, the advertisement client 210 analyzes and stores the transmitted metrics information at step 545. In some cases, if additional terminal context information at the time when the advertisement exposure occurs, for example, terminal location information, etc., is included in the metrics criteria applied in step 520, the advertisement client 210 gathers the corresponding terminal context information, such as at step 540. To do this, the advertisement client 210 obtains context information such as location from another client, an enabler or the like in the terminal.

In another example, the advertisement application 220 transmits the overall information related to advertisement use irrespective of the metrics measurement criteria to the advertisement client 210, and the advertisement client 210 collects and stores necessary utilization information using the information transmitted from the advertisement application 220 as well as applying metrics measurement criteria transmitted from the advertisement server 200.

Then, when a metrics information request for a specific advertisement or the entire advertisement is transmitted from an advertisement server 200 at step 550, metrics information stored for some time which corresponds to that request is transmitted to the advertisement server 200. In some cases, metrics information can be transmitted periodically or immediately according to a preset value without a request from the advertisement server 200. At this time, if there is collected context information, metrics information that includes the collected context information is transmitted to the advertisement server 200 at step 555. By doing this, the advertisement server can obtain information according to metrics criteria differently assigned for each advertisement, thereby monitoring advertisement use details easily and grasping each user's response to an advertisement in real time and therefore measuring the advertisement effect.

According to the present invention, when an advertisement server sets the native advertisement measurement criteria, there is no reason that the advertisement server needs to transmit a parameter for advertisement measurement in a message format so that the amount of transmission load can be reduced. Also, the present invention can insert measurement criteria for advertisement use details that an advertiser intends to obtain from the advertisement server when producing an advertisement in a metadata format and transmit it to the advertisement client, so that the advertisement server can obtain desired advertisement measurement values in a different way for each advertisement without any specific, additional message definition.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method of measuring advertisement metrics in a mobile advertisement system including an advertisement server, an advertisement client, and an advertisement application, comprising the steps of
receiving by the advertisement client an advertisement package containing metrics measurement criteria to be measured for each advertisement;
transmitting advertisement content within the advertisement package to the advertisement application;
storing metrics information transmitted from the advertisement application, the metrics information being an advertising measurement result; and
delivering corresponding metrics information to the advertisement server.

2. The method of claim 1, wherein the advertisement package comprises the advertisement content and metadata, where the metrics measurement criteria are inserted.

3. The method of claim 1, wherein the advertisement package comprises additional data containing the advertisement content, metadata of the advertisement content and the metrics measurement criteria.

4. The method of claim 1, wherein the step of transmitting advertisement content to the advertisement application comprises grasping the metrics measurement criteria included in the received advertisement package when the advertisement package is received from the advertisement server, and transmitting the advertisement package except for the grasped metrics measurement criteria to the advertisement application.

5. The method of claim 4, wherein the step of storing the transmitted metrics information comprises gathering and storing metrics information suitable for the grasped metrics measurement criteria from metrics information transmitted from the advertisement application.

6. The method of claim 5, wherein the step of delivering the corresponding metrics information comprises receiving a request for metrics information for a specific advertisement and the entire advertisement from the advertisement server, and delivering metrics information corresponding to the request.

7. An apparatus of measuring advertisement metrics, comprising:
an advertisement transmitting/receiving unit for receiving from an advertisement and storing an advertisement package containing metrics measurement criteria to be measured for each advertisement server and transmitting advertisement content within the advertisement package to an advertisement application; and
a reporting unit for storing metrics information transmitted from the advertisement application and delivering corresponding metrics information to the advertisement server, the metrics information being an advertisement measurement result.

8. The apparatus of claim 7, further comprising an advertisement package monitoring part for analyzing metadata within the received advertisement package and grasping metrics measurement criteria representing what advertisement use details should be measured and reported through the analysis result.

9. The apparatus of claim 7, wherein the advertisement package comprises additional data containing the advertisement content, metadata of the advertisement content and the metrics measurement criteria.

10. The apparatus of claim 7, wherein the advertisement package comprises the advertisement content and metadata, where the metrics measurement criteria are inserted.

11. The apparatus of claim 7, wherein the reporting part delivers metrics information corresponding to a request from the advertisement server when the metrics information request for specific advertisement and the entire advertisement is received from the advertisement server.

12. A method of measuring advertisement metrics in a mobile advertisement system including an advertisement server, an advertisement client, and an advertisement application, comprising the steps of:
transmitting from the advertisement server to the advertisement client an advertisement package containing metrics measurement criteria to be measured for each advertisement; and
receiving, through the advertisement client, metrics information from the advertisement application in response to delivering the advertisement package through the advertisement client to the advertisement application, the metrics information being an advertisement measurement result.

13. The method of claim 12, wherein the advertisement package comprises the advertisement content and metadata, where the metrics measurement criteria are inserted.

14. The method of claim 12, wherein the advertisement package comprises additional data containing the advertisement content, metadata of the advertisement content and the metrics measurement criteria.

15. The method of claim 12, wherein the advertisement package delivered to the advertisement application is delivered to the advertisement application after metrics measurement criteria grasped by the advertisement client are excluded.

16. The method of claim 12, further comprising transmitting a metrics information request for a specific advertisement or the entire advertisement to the advertisement client by the advertisement server before the advertisement server receives the metrics information through the advertisement client.

17. The method of claim 16, wherein the metrics information received through the advertisement client corresponds to metrics information responding to the metrics information request from the advertisement server.
